(19) United States
(12) Patent Application Publication
(10) Pub. No.: US 2023/0228349 A1
(43) Pub. Date: Jul. 20, 2023

(54) COMPOSITION OF A MULTI-LAYER TUBE WITH A POLYAMIDE OUTER LAYER AND PROCESS FOR MAKING

(71) Applicant: Cooper-Standard Automotive, Inc., Northville, MI (US)

(72) Inventors: Tao Nie, Rochester Hills, MI (US); Brian J. Cardwell, Ypsilanti, MI (US)

(73) Assignee: Cooper-Standard Automotive, Inc., Northville, MI (US)

(21) Appl. No.: 18/148,269

(22) Filed: Dec. 29, 2022

Related U.S. Application Data
(60) Provisional application No. 63/295,025, filed on Dec. 30, 2021.

(51) Int. Cl. F16L 11/04; F16L 59/14

(52) U.S. Cl. CPC F16L 11/04; F16L 59/143; F16L 2011/047

(57) ABSTRACT

The present disclosure provides a multi-layer tube comprising a thermoplastic elastomer vulcanizate inner layer, a polyolefin or polyamide intermediate layer and a foamed thermoplastic elastomeric outer layer. The intermediate layer may comprise multiple layers selected from polyolefins, adhesive, polyamides and or thermoplastic vulcanizates. The other layers may also be foamed insulative materials. An adhesive layer may be present depending upon the properties of the selected materials. One or more layers within the multi-layer tube may be foamed.

### FIELD

The present disclosure relates to a tube for use in a motor vehicle. More particularly, the present disclosure relates to a multi-layer tube having a thermally insulated layer which can be employed for conveying fluids for temperature control in a motor vehicle.

### BACKGROUND

Single and multi-layer tubes of synthetic materials such as plastics and elastomers have been proposed for coolant lines. Coolant lines for electrical and motor vehicles are growing in demand. Cooling systems for electrical vehicles and motor vehicles with internal combustion engines are similar. Both circulate coolant through a series of heat exchange pipes to transfer heat to and away from various parts of the vehicle.

Mid-temperature coolant systems operate at about -40° C. to about 90 to about 120° C. continuous temperature with a peak temperature of about 5 to about 10° C. higher than the continuous temperature. It is important that a coolant tube be constructed of material that provides a barrier against coolant diffusion and leakage in the temperature range of operation. The tube must have good creep resistance in the operating temperature range and exhibit good hoop strength with connections to other tubes to avoid leaks developing at the stress points. The tube must also retain its burst pressure strength and cold impact resistance during operation while transporting coolant at higher pressure utilizing materials that are resistant to external and internal chemical exposures. Lastly, the tube should have adequate ability to seal for connection to components of the system or to other tubes often by means of a fitted connection including a barbed connection.

Finding a material that has all of these properties and is at the same time economical is a challenge. Multi-layer tubes can be useful to provide all the essential properties in a single tube. In general, the most successful multi-layer tubes have been co-extruded employing an outer layer composed of a material resistant to the exterior environment. The innermost layer is composed of a material which is chosen for its ability to block diffusion of coolant at low cost while exhibiting long-term serviceability.

Multi-layer coolant tubes made of a polyamide outer layer and a polyolefin inner layer have been utilized. Polyamide provides good mechanical and chemical properties including high burst strength at relatively higher temperatures. However, some polyamides may have relatively weak resistance to hydrolysis in coolant/water environment. The polyolefin inner layer protects the outer layer of polyamide from hydrolytic degradation by shielding it from water transported in the tube.

Polyolefin inner layers may have reduced creep stress cracking resistance. Polypropylene is reported to form microcracks that allow leakage of cooling fluid to the polyamide outer layer. The hydrolysis which then occurs reduces its bursting strength which can lead either to pipe failure or leaks at the connections.

Multi-layer coolant tubes can be improved if the tube had insulative properties that minimized heat flow between the flowing liquids within the tubes and the exterior environment which allowed for the liquids to maintain their temperature with minimal influence of the exterior temperatures. It has been found that a blowing agent can be used to add insulative properties to at least one layer of the multi-layer coolant tube and allow the temperature of the liquid within the tube to maintain its temperature.

It is an objective to provide a low-cost multi-layer tube that will transport fluids exceptionally in a motor vehicle at mid-temperature continuous use range.

### SUMMARY

The present disclosure provides a multi-layer tube and a process for making it comprising a polyamide outer layer that has been subjected to a blowing agent to introduce insulative pores or particles, a polyolefin intermediate layer (such as polyethylene) and an inner layer that may be a thermoplastic elastomeric or a polyolefin. The polyamide outer layer provides sufficient mechanical strength and environmental protection, the polyolefin intermediate layer shields the polyamide from contact with water to avoid hydrolytic degradation and prevents the coolant diffusion and permeation. The polyamide outer layer further comprises the result of a blowing agent which either introduces pores or small particles of an insulative material that increases the thermal insulation of the tube. In some cases, the polyolefin intermediate layer may contain pores or particles from a blowing agent. The inner layer acts as an excellent interface material to the aqueous coolant environment and guards against stress cracking in the polyolefin intermediate layer 16 and provides an excellent seal for connection.

### DETAILED DESCRIPTION

The present disclosure is a multi-layer tube. The multi-layer tube is ideal for medium temperature coolant line applications but may be useful in other applications. The tube has at least an inner or first layer, at least one intermediate or second layer, and at least a third or outer layer. The tube may have a polyamide outer layer, a polyolefin intermediate layer and a thermoplastic elastomeric inner layer. The polyamide outer layer provides sufficient mechanical strength and the polyolefin intermediate layer shields the polyamide from contact with water to avoid hydrolytic degradation. The present disclosure incorporates a thermoplastic elastomeric inner layer to guard against creep stress cracks in the polyolefin intermediate layer and provide an excellent seal with connectors or other tubes.

The multi-layer tube may be fabricated by simultaneously co-extruding thermoplastic materials in a conventional co-extrusion process. The tube may either be co-extruded to a suitable length or may be co-extruded in continuous length and cut to fit the given application subsequently. The tube of the present disclosure may have an outer diameter up to about 50 mm with an inner diameter of about 5 mm to about 30 mm. The total wall thickness may be from 0.5 to about 7 mm, suitably about 0.9 to about 4 mm, and preferably from 1 to about 3 mm. The tube may also have a smooth bore or a corrugated surface.

The tube may be used for medium temperature coolant transport for motors or engines in both electrical and internal combustion vehicles. Typically, the coolant will be an aqueous glycol-based coolant, such as ethylene glycol. The tube 10 may typically encounter about 90° C. to about 120° C. continuous temperature applications and a peak temperature of about 125° C. to about 135° C. temperature at about 1 to 4 bar maximum gauge pressure.

The tube comprises an inner layer. The inner layer may predominantly comprise a thermoplastic elastomeric material chosen for its flexibility and connection seal-ability. As used herein, the term “predominant” or “predominate” means greater than 50%, suitably greater than 75% and preferably greater than 90%. The inner layer of the tube can accommodate a friction fit connection such as a multi-barb male connector. The inner layer must have properties that sealingly conform around the multi-barb male connector inserted into the tube to establish a fluid-tight connection that endures over the life of the tube 10. The inner layer may have a wall thickness of about 0.1 to about 1 mm and preferably about 0.1 to about 0.7 mm.

A suitable material for the inner layer is a thermoplastic elastomer (TPE). A TPE comprises a primary phase of thermoplastic with a secondary phase of an elastomer or a rubber. TPE has properties of thermoplastics but with hardness more like rubber. A TPE that adheres to the intermediate layer is most suitable. Suitable TPE’s include thermoplastic rubbers with a composition composed of a styrene-ethylene/butylene-styrene block copolymers and polyvinyl chloride compounds with plasticizers.

A preferred TPE is predominantly a thermoplastic vulcanizate (TPV). A TPV is a vulcanized alloy of mostly fully cured ethylene-propylene diene monomer (EPDM) particles encapsulated in a polypropylene matrix. The polypropylene matrix comprises the primary phase and the ethylene-propylene diene monomer comprises the secondary phase. TPV is commercially available from various suppliers including under the SANTOPRENE product line, a thermoplastic rubber composition, from ExxonMobil Chemical in Irving, Texas, and the SARLINK product line, an oil resistant thermoplastic composition commercially available from Teknor Apex of Pawtucket, Rhode Island. TPV is also available from Elastron Group which is manufactured in Kocaeli, Turkey. A preferred TPV should have a Shore A Hardness from about 55 to about 95, and preferably from about 80 to about 90 based on ISO 868. The thermoplastic, such as polypropylene, without a phase of EPDM will have a greater Shore A Hardness. If desired, these materials may be modified to include flame retardants, plasticizers, and other similar additives.

In an embodiment, the intermediate layer may predominantly comprise a melt processable, polyolefinic material. Polyolefinic materials provide a sufficient barrier to water to protect the polyamide outer layer from hydrolysis. A suitable polyolefinic material is polyethylene or polypropylene. The intermediate layer may predominantly comprise polypropylene. Polypropylene has excellent resistance to permeation. Polypropylene is particularly suitable if the inner layer is a TPE with the primary phase comprising polypropylene for mutual adhesion properties. The polypropylene material may comprise a propylene homopolymer or a co-polymer of propylene. A polypropylene copolymer comprises a propylene polymerized with at least another alkene monomer. The other alkene monomer may be a substituted or unsubstituted alkene having no more than four carbon atoms, vinyl alcohol or vinyl acetate, and mixtures thereof. In a copolymer, the polypropylene is covalently bonded with the other alkene monomer in the polymer chain.

Polypropylene homopolymers or copolymers can be manufactured by any known process. For example, propylene polymers can be prepared from propene monomer in the presence of Ziegler-Natta catalyst systems or metallocene catalyst systems. Block copolymers can be manufactured similarly except propylene is generally first polymerized by itself or with another alkene monomer in the first reactor phase to form the semicrystalline matrix and low crystallinity or amorphous segments of propylene and the other alkene monomer are then copolymerized, in a second stage or subsequent stages, in the presence of the polymer produced in the first reactor. The other alkene monomer should have no more than four carbons and is preferably ethylene. Commercial polypropylene random and block copolymers are widely available from multiple polypropylene producers and encompass a wide range of grades. Random polypropylene copolymers are preferred.

Random copolymers of propylene can contain the comonomers inserted in a random manner so that the main chain crystallinity is disrupted, leading to drops in the melting point of the copolymer from about roughly 165° C. for the homopolypropylene to as low as about 130° C. in the random copolypropylene depending on the amount and type of comonomer employed.

The copolymers of polypropylene can be copolymerized in a multi-step process to obtain block copolypropylenes where chain segments consist of relatively crystalline homopolypropylene or random copolypropylene and chain segments of relatively amorphous or low crystallinity propylene ethylene copolymers. The melting points of the block copolymers will be dominated by the more crystalline segments of the copolymer to give a melting point of about 165° C. for a homopolypropylene block copolymer or lower for a random copolypropylene block copolymer.

Ethylene is the preferred comonomer for a polypropylene copolymer, but other olefin monomers may be suitable. Additionally, random copolypropylene is preferred over block copolypropylene. The mass fraction of comonomer, particularly ethylene, in the propylene copolymer should be between about 0.1 and about 15 wt%, preferably between about 0.2 and about 6 wt%.

In another embodiment, the tube may comprise an intermediate layer of polyethylene. Preferably, the intermediate layer is a HDPE. HDPE is known for its high strength-to-density ratio. HDPE has an excellent low temperature impact resistance. The density of the HDPE can range from 930 to 970 kg/m³ and is preferably 940 to 950 kg/m³. HDPE has little branching resulting in its higher density and stronger intermolecular forces and tensile strength than for low density polyethylene. Ethylene monomer may be polymerized with Ziegler-Natta catalyst under appropriate polymerization conditions to yield HDPE. The HDPE should have a cold tensile impact strength of about 95 to about 105 KJ/m² at -30° C. using the ISO 8256 test. The HDPE has a relatively lower hoop strength.

The multi-layer tube may have an outer layer predominantly comprising a polyamide. Polyamides which can be used are aliphatic homopolycondensates and copolycondensates, for example PA 46, PA 66, PA 68, PA 610, PA 612, PA 410, PA 810, PA 1010, PA 412, PA 1012, PA 1212, PA 6, PA 7, PA 8, PA 9, PA 10, PA 11 and PA 12. The designation of the polyamides corresponds to the international standard, with the first digit(s) indicating the number of carbon atoms in the starting diamine and the last digit(s) indicating the number of carbon atoms in the dicarboxylic acid. If only one number is given, this means that an α,ω-aminocarboxylic acid or the lactam derived therefrom has been used as starting material; otherwise, reference may be made to H. Domininghaus, Die Kunststoffe und ihre Eigenschaften, pages 272 ff., VDI-Verlag, 1976.

The use of aliphatic PA612 is particularly preferred since this polyamide has a high bursting strength at high use temperatures and secondly has satisfactory dimensional stability and excellent resistance to chemical attack from the environment. For example, PA612 can have a flexural modulus of 620 MPa at dry conditions. If copolyamides are used, these can comprise, for example, adipic acid, sebacic acid, suberic acid, isophthalic acid, terephthalic acid, naphthalene-2,6-dicarboxylic acid, etc., as coacid and bis(4-aminocyclohexyl)methane, trimethylhexamethylenediamine, hexamethylenediamine or the like as codiamine. Lactams such as caprolactam or laurolactam and aminocarboxylic acids such as 11-aminoundecanoic acid can likewise be incorporated as cocomponents.

Further suitable polyamides are mixed aliphatic/aromatic polycondensates. The polyamide composition can comprise either one of these polyamides or a plurality thereof as a mixture. Furthermore, up to 50 wt.% of other thermoplastics can be present as long as these do not impair the bonding capability. Further thermoplastics which may be present are, in particular, rubbers which increase the impact toughness, e.g. ethylene-propylene or ethylene-propylene-diene copolymers, polyolefins, polypentenylene, polyoctenylene, random or block copolymers of alkenylaromatic compounds with aliphatic olefins or dienes or core-shell rubbers having an elastic core of (meth)acrylate, butadiene or styrene-butadiene rubber having a glass transition temperature T_{g} of <-10° C., with the core being able to be crosslinked and the shell being able to be composed of styrene and/or methyl methacrylate and/or further unsaturated monomers.

The polyamide preferably has an excess of amino end groups, which generally results from a diamine being used as molecular weight regulator in the preparation. The excess of amino end groups can also be obtained by mixing a polyamide which is low in amino groups and a polyamide which is rich in amino groups. The ratio of amino end groups to carboxyl end groups should then be at least 51:49, preferably at least 55:45, particularly preferably at least 60:40 and in particular at least 70:30.

In addition, the polyamide can further comprise relatively small amounts of additives required for setting particular properties. Examples are pigments or fillers such as carbon black, titanium dioxide, zinc sulfide, silicates or carbonates, processing aids such as waxes, zinc stearate or calcium stearate, flame retardants such as magnesium hydroxide, aluminum hydroxide or melamine cyanurate, glass fibers, antioxidants, UV stabilizers and additives which give the product anti-electrostatic properties or electrical conductivity, e.g. carbon fibers, graphite fibrils, stainless steel fibers or conductive carbon black.

In a specific embodiment, the polyamide composition may contain from 1 to 25% by weight of plasticizer, particularly preferably from 2 to 20% by weight and in particular from 3 to 15% by weight. Customary compounds suitable as plasticizers are, for example, esters of p-hydroxybenzoic acid having from 2 to 20 carbon atoms in the alcohol component or amides of arylsulfonic acids having from 2 to 12 carbon atoms in the amine component, preferably amides of benzenesulfonic acid. Possible plasticizers are, for example, ethyl p-hydroxybenzoate, octyl p-hydroxybenzoate, i-hexadecyl p-hydroxybenzoate, N-n-octyltoluenesulfonamide, N-n-butylbenzenesulfonamide or N-2-ethylhexylbenzenesulfonamide. The outer layer may have a wall thickness of about 0.1 to about 1 mm and preferably about 0.1 to about 0.8 mm.

The inner layer may be co-extruded with the other layers during the extrusion process or other layers may be extruded around the inner layer in a subsequent process such as by crosshead extrusion. The outer layer may be co-extruded with the other layers during the extrusion process or may be extruded around other layers in a subsequent process such as by crosshead extrusion.

In order to get strong adhesion between the intermediate layer comprising polyolefin and the outer layer comprising a polyamide an adhesive layer may be employed. The tube may have an adhesive layer interposed between the intermediate layer and the outer layer. In one possible embodiment, the material of the intermediate layer is adhesion-modified, e.g. by incorporation of acid anhydride groups. The material of the intermediate layer may also be present as a mixture of an unmodified polypropylene type with a modified propylene type. In a second possible embodiment, the intermediate layer is made up of two sublayers of which the one adjacent to the polyamide layer is adhesion-modified and the other does not have to be adhesion-modified. Apart from the adhesion modification, different polypropylene molding compositions can be used here as layer materials. In a further possible embodiment, an adhesive layer having a different composition may be located between the intermediate layer and the outer layer. In this regard, polyamide/polypropylene blends, for example, in which at least part of the polypropylene component is adhesion-modified may be used.

No adhesive layer need be used between the intermediate layer and the inner layer. We have found that an inner layer of TPE, and particularly a TPV, may not require an adhesive layer and may be directly bonded to the intermediate layer of polyolefin. An inner layer 12 of TPE predominantly comprising polypropylene is particularly adhesive to an intermediate layer comprising predominantly comprising polypropylene. In an embodiment, a TPV with a primary phase predominantly comprising polypropylene and a secondary phase predominantly comprising EPDM bonds well to the intermediate layer 16 predominantly comprising polypropylene.

In order to provide reduced thermal conductivity, a chemical blowing agent may be added to at least the outer layer to form a foamed outer layer containing pores that reduce thermal conductivity. A volatile foaming agent is used to send foamable polymer particles into the outer layer of polymer as it is extruded. These particles expand as the polymer cools and form a hollow balloon-like structure that introduce improved thermal properties to the material. The particular foaming agent that is selected based upon the degree of expandability that is needed at the temperatures used in the process. One foaming agent that may be used has a shell made from acrylonitrile co-polymers and a core of liquid hydrocarbons. The particles expand by about a factor of 3 at the temperature of the materials during extrusion of the layers that form the multi-layer tube. Other faming agents such as polystyrene particles, polyolefins, or acrylic resins may also be used.

A higher comonomer propylene-α-olefin copolymer-based adhesive may be used as the adhesive layer. A suitable adhesive for the adhesive layer 22 can be a polypropylene based adhesive. A preferred polypropylene-based adhesive is an anhydride-modified polypropylene resin. Each adhesive layer 22 may have a wall thickness of about 0.05 to about 0.5 mm and preferably about 0.05 to about 0.2 mm.

The tube of the present invention is suitable for use in motor vehicles and may comprise an outer layer that is non-reactive with the external environment and can withstand various shocks, vibrational fatigues and changes in temperature, as well as exposure to various corrosive or degradative compounds to which it would be exposed through the normal course of operation of the motor vehicle. Suitable materials for use in the present invention may be composed of any melt-processible extrudable thermoplastic materials which are resistant to ultraviolet degradation, extreme changes in heat. The material of choice may also exhibit resistance to environmental hazards such as exposure to road salt, zinc chloride and CaCl₂, and resistance to degradation upon contact with materials such as engine oil and brake fluid.

The multi-layer tube has strong properties necessary for automotive coolant transport. The tube is expected to withstand impact of 1.5 J (2 ft-lbs) of force at -40° C. and exhibits a coolant permeation resistance better than traditional polyamide tubes. The tube is capable of being made into a corrugated tube without delamination and has adequate resistance to burst pressures that it will encounter during typical operation and also withstand vacuum pressure that it will encounter during manufacturing and testing. The tube also has sufficient seal-ability and hoop strength to enable it to couple with a barbed connection without leakage. The tube has improved thermal insulation properties over those tubes that do not contain

At least the outer layer of the multi-layer tube has been treated by a blowing agent which has introduced either particles or pores that increase the thermal insulative properties of the multi-layer tube to maintain the temperature of a liquid transported within. In some cases, the particles are thermal expandable microspheres that expand upon cooling. The outer layer may further comprise a cellular polymeric structure.

In addition to the above embodiments, in some cases it may be desirable to add an additional layer of a polyamide, such as PA11 as a further outer layer outside of the layer that was subjected to the blowing agent.

Several different configurations of layers within the multi-layer tube have been found to be particularly advantageous. In one embodiment, the inner layer is a thermoplastic elastomer and more particularly a thermoplastic vulcanizate which may have a layer of high density polyethylene on top of it. Then another layer of a thermoplastic vulcanizate is followed by an outer layer of a foamed thermoplastic vulcanizate. The foamed layer serves as an insulation layer. In a second embodiment, the inner layer may be polypropylene with an adhesive layer used if necessary for a PA612 nylon layer to adhere to the inner layer. Then the outer layer of the thermoplastic vulcanizate is found as an insulation layer. A third embodiment that is found advantageous has an inner layer of a thermoplastic vulcanizate, a layer of polypropylene, an adhesive layer, a layer of PA612 polyamide and then the outer layer of the foamed thermoplastic vulcanizate. In any of the embodiments a layer may be a foamed layer as determined to be preferred by the

While the following is described in conjunction with specific embodiments, it will be understood that this description is intended to illustrate and not limit the scope of the preceding description and the appended claims.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

1. A multi-layer tube comprising:
an inner layer comprising a layer of thermoplastic elastomer or polypropylene;
at least one intermediate layer comprising a polyamide, polyolefin, a thermoplastic elastomer or an adhesive; and
an outer layer comprising a cellular polymeric structure produced by introduction of a blowing agent or microcellular materials into a thermoplastic elastomer.

2. The multi-layer tube of claim 1 wherein said thermoplastic elastomer in said inner layer or said outer layer comprises a foamed thermoplastic vulcanizate.

3. The multi-layer tube of claim 1 wherein the at least one intermediate layer comprises a polypropylene layer adjacent to said inner layer, an adhesive layer on top of said polypropylene layer and a polyamide layer on top of said adhesive layer.

4. The multi-layer tube of claim 1 wherein said at least one intermediate layer comprises a high-density polyethylene or polypropylene layer adjacent to said inner layer and a layer of thermoplastic elastomer on top of said high density polyethylene or polypropylene layer.

5. The multi-layer tube of claim 1 further comprising an adhesive layer between the intermediate layer and the outer layer.

6. The multi-layer tube of claim 1 wherein said adhesive layer is a polypropylene based adhesive.

7. The multi-layer tube of claim 1 wherein the outer layer is an insulation layer.

8. The multi-layer tube of claim 1 wherein said inner layer comprises a foamed thermoplastic vulcanizate.

9. The multi-layer tube of claim 1 wherein said inner layer comprises a thermoplastic vulcanizate.

10. The multi-layer tube of claim 1 wherein a layer of thermoplastic vulcanizate is under said outer layer.

11. The multi-layer tube of claim 3 wherein said polyamide comprises a PA612 nylon.

12. The multi-layer tube of claim 1 wherein said polyolefin comprises polypropylene or high-density polyethylene.

13. The multi-layer tube of claim 1 wherein at least one layer within said at least one intermediate layer has been foamed by introduction of a blowing agent or microcellular materials into said at least one intermediate layer.

14. The multi-layer tube of claim 13 wherein said thermoplastic vulcanizate has been foamed.

15. The multi-layer tube of claim 13 wherein said at least one intermediate layer comprises a cellular polymeric.
